(19) United States
(12) Patent Application Publication
(10) Pub. No.: US 2025/0286194 A1
(43) Pub. Date: Sep. 11, 2025

(54) BATTERY MODULE

(71) Applicant: HONDA MOTOR CO., LTD., Tokyo (JP)

(72) Inventors: Hirokazu WATANABE, Saitama (JP); Koji NOZOE, Tokyo (JP); Ryotaro KANEKO, Saitama (JP); Takeo FUJII, Saitama (JP)

(21) Appl. No.: 19/063,110

(22) Filed: Feb. 25, 2025

(30) Foreign Application Priority Data
Mar. 7, 2024 (JP) 2024-034707

(51) Int. Cl. H01M 50/242; H01M 50/204; H01M 50/291

(52) U.S. Cl. CPC H01M 50/242; H01M 50/204; H01M 50/291

(57) ABSTRACT

Provided is a battery including: a battery cell stack in which a plurality of battery cells are stacked; a pair of plate members provided at opposite ends of the battery cell stack in a stacking direction; and a cushioning material disposed between the plurality of battery cells and/or between the battery cell stack and each of the plate members, the cushioning material including a pair of first elastic members arranged on opposite outer sides in the stacking direction of the battery cell stack; and a second elastic member disposed between the pair of first elastic members. The second elastic member is a molding having a shape in which 2N layers of corrugated plate springs each having a concave portion and a convex portion that are alternately and continuously arranged and extending in a predetermined direction are stacked in the stacking direction of the battery cell stack.

This application is based on and claims the benefit of priority from Japanese Patent Application No. 2024-034707, filed on 7 Mar. 2024, the content of which is incorporated herein by reference.

### BACKGROUND OF THE INVENTION

### Field of the Invention

The present invention relates to a battery module.

### Related Art

In recent years, research and development of battery modules that contribute to energy efficiency has been carried out in order to ensure many people have access to reasonable, reliable, sustainable, and advanced energy.

A battery module includes, for example, a battery cell stack in which a plurality of battery cells are stacked. Here, because each battery cell expands and contracts with charging and discharging, the battery module includes, for example, a pair of end plates provided at opposite ends of the battery cell stack in a stacking direction, and a bind bar that binds the battery cell stack between the pair of end plates.

Japanese Unexamined Patent Application, Publication No. 2022-156427 describes a power storage device including a power storage module including a plurality of power storage cells stacked in a stacking direction, a housing case housing the power storage module, and a restriction unit disposed between the power storage cells. This restriction unit includes a first flat plate and a second flat plate that are spaced apart in the stacking direction, and a corrugated plate disposed between the first flat plate and the second flat plate.
Patent Document 1: Japanese Unexamined Patent Application, Publication No. 2022-156427

### SUMMARY OF THE INVENTION

In a power storage device described in Japanese Unexamined Patent Application, Publication No. 2022-156427, however, when a restriction unit is compressed due to expansion of a power storage cell during charging, a difference in surface pressure increases between portions of first and second flat plates in contact with a corrugated plate and portions of the first and second flat plates that are not in contact with the corrugated plate, which reduces uniformity of the surface pressure in the restriction unit.

An object of the present invention is to provide a battery module capable of increasing uniformity of a surface pressure loaded on a cushioning material.

(1) A battery module includes: a battery cell stack in which a plurality of battery cells are stacked; a pair of plate members provided at opposite ends of the battery cell stack in a stacking direction; and a cushioning material disposed between the plurality of battery cells and/or between the battery cell stack and each of the plate members. The cushioning material includes a pair of first elastic members arranged on opposite outer sides in the stacking direction of the battery cell stack; and a second elastic member disposed between the pair of first elastic members. The second elastic member is a molding having a shape in which 2N layers (N being a natural number) of corrugated plate springs each having concave portions and convex portions that are alternately and continuously arranged, and extending in a predetermined direction are stacked in the stacking direction of the battery cell stack, and in which the concave portions and the convex portions of the corrugated plate springs adjacent to each other are integrated.

(2) In the second elastic member of the battery module according to (1), a region in which the concave portion and the convex portion are integrated has a thickness greater than a thickness of a region in which the concave portion and the convex portion are not integrated.

(3) In the second elastic member of the battery module according to (1) or (2), a region in which the concave portion and the convex portion are not integrated has rounded ends that are opposite to each other in a direction in which the concave portions and the convex portions are alternately and continuously arranged.

(4) In the battery module according to any one of (1) to (3), each of the battery cells is a solid-state battery cell.

(5) A method for manufacturing the battery module according to any one of (1) to (4) includes: installing a core inside a mold; molding the second elastic member by using the mold in which the core is installed; and cooling the core that is present inside the second elastic member.

(6) A method for manufacturing the battery module according to any one of (1) to (4) includes: installing a core inside a mold; molding a precursor of the second elastic member by using the mold in which the core is installed; removing the mold from the precursor of the second elastic member; and cutting the precursor of the second elastic member from which the mold has been removed, to obtain the second elastic member.

According to the present invention, a battery module capable of increasing uniformity of surface pressure of a cushioning material can be provided.

### BRIEF DESCRIPTION OF THE DRAWINGS

FIG. 1 is a cross-sectional view showing a battery module according to one embodiment of the present invention;

FIG. 2 is a partially enlarged view of the battery module of FIG. 1;

FIG. 3 is a partially enlarged view of a second elastic member of FIG. 2;

FIG. 4 is a cross-sectional view showing a corrugated plate spring illustrating a shape of the second elastic member of FIG. 2; and

FIG. 5 is a cross-sectional view illustrating a manufacturing method of the second elastic member of FIG. 2.

### DETAILED DESCRIPTION OF THE INVENTION

Hereinafter, embodiments of the present invention will be described with reference to the drawings.

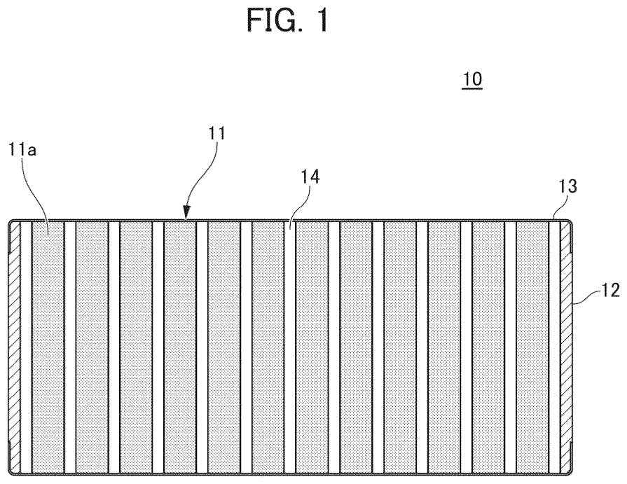

FIG. 1 shows a battery module according to one embodiment of the present invention.

A battery module 10 includes a battery cell stack 11 in which a plurality of battery cells 11a are stacked, end plates 12 as a pair of plate members provided at opposite ends of the battery cell stack 11 in a stacking direction, and bind bars 13 as binding members that bind the battery cell stack 11 between the pair of end plates 12. Here, the bind bars 13 are installed at two locations of upper and lower parts in the drawing, respectively.

In the battery module 10, cushioning materials 14 are arranged between the plurality of battery cells 11a and between the battery cell stack 11 and each of the end plates 12, respectively.

Alternatively, the cushioning material 14 may be disposed between the plurality of battery cells 11a or between the battery cell stack 11 and the end plate 12.

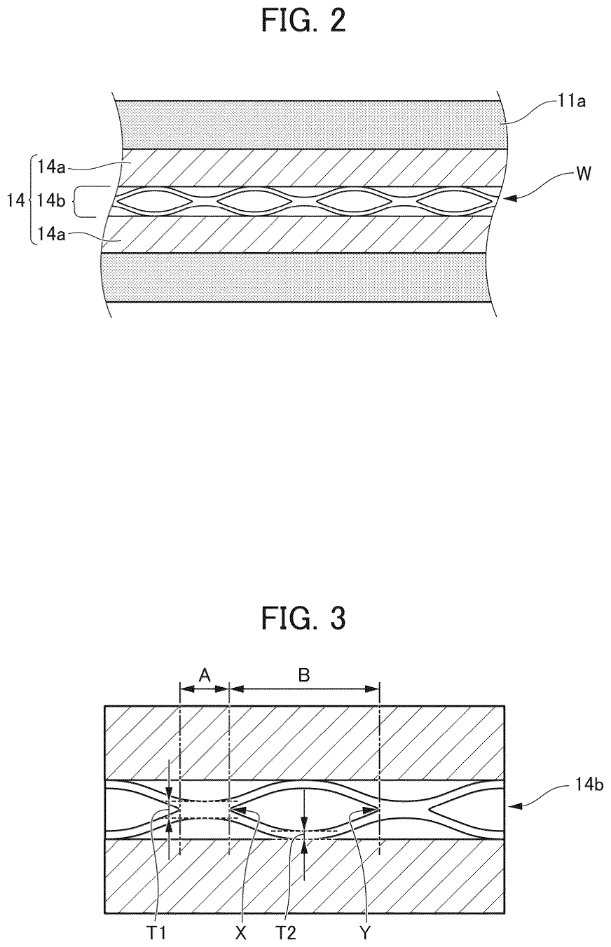

As shown in FIG. 2, the cushioning material 14 includes a pair of first elastic members 14a arranged on opposite outer sides of the battery cell stack 11 in the stacking direction, and a second elastic member 14b disposed between the pair of first elastic members 14a. Consequently, hysteresis loss of the cushioning material 14 is reduced.

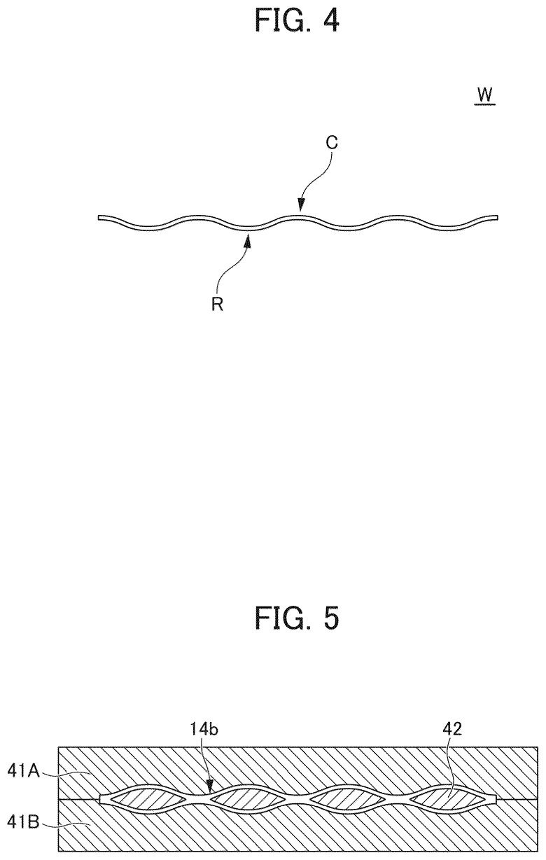

The second elastic member 14b is a molding having a shape in which two layers of corrugated plate springs W (see FIG. 4) having a concave portion R and a convex portion C that are alternately and continuously arranged and extending in a predetermined direction are stacked in the stacking direction of the battery cell stack 11, and in which the concave portion R and the convex portion C of the corrugated plate springs W adjacent to each other are integrated. Consequently, manufacturing stability improves as compared with a case in which two layers of corrugated plate springs W are stacked and then bonded. In addition, the concave portion R and the convex portion C protrude downward and upward in the stacking direction of the battery cell stack 11, respectively (see FIG. 2).

Here, when the cushioning material 14 is compressed due to expansion of the battery cell 11a during charging, the first elastic member 14a is interposed between the battery cell 11a and the second elastic member 14b, and hence a difference in surface pressure decreases between a portion of the first elastic member 14a that is in contact with the second elastic member 14b and a portion of the first elastic member 14a that is not in contact with the second elastic member 14b, which increases uniformity of the surface pressure.

In the second elastic member 14b, as shown in FIG. 3, a region A in which the concave portion R and the convex portion C (see FIG. 4) of the adjacent corrugated plate springs W are integrated has a thickness T1 greater than a thickness T2 of a region B in which the concave portion R and the convex portion C of the adjacent corrugated plate springs W are not integrated. This increases strength of the second elastic member 14b. As a result, when the second elastic member 14b is compressed due to the expansion of the battery cell 11a during charging, the second elastic member 14b is inhibited from being damaged even by stress concentrated on the region A in which the concave portion R and the convex portion C of the adjacent corrugated plate springs W are integrated.

In the second elastic member 14b, as shown in FIG. 3, opposite ends X and Y of the region B in which the concave portion R and the convex portion C of the adjacent corrugated plate springs W are not integrated in a direction in which the concave portion R and the convex portion C are alternately and continuously arranged are rounded. This also increases the strength of the second elastic member 14b. As a result, when the second elastic member 14b is compressed due to the expansion of the battery cell 11a during charging, the second elastic member 14b is inhibited from being damaged even by the stress concentrated on the region A in which the concave portion R and the convex portion C of the adjacent corrugated plate springs W are integrated.

In addition, the number of layers of the stacked corrugated plate springs W in the shape in which the second elastic member 14b is molded is not limited to two and may be 2N (N is a natural number). This N is not particularly limited and is, for example, 1 or more and 3 or less.

Alternatively, a plurality of second elastic members 14b may be arranged between the pair of first elastic members 14a. In this case, the second elastic members are arranged so that the concave portion R and the convex portion C of the corrugated plate springs W constituting the adjacent second elastic members 14b are in opposing contact with each other. In this arrangement, a part of the concave portion R and convex portion C that are in opposing contact with each other may be bonded, for example, with an elastic adhesive. Furthermore, the number of the second elastic members 14b arranged between the pair of first elastic members 14a is not particularly limited and is, for example, 2 or more and 3 or less.

In addition, a part of the second elastic member 14b may be bonded to the first elastic member 14a, for example, with an elastic adhesive. This increases strength of the cushioning material 14.

The second elastic member 14b is manufactured, for example, by installing a core 42 inside molds 41A and 41B and then molding the member (see FIG. 5). Subsequently, after removing the molds 41A and 41B from the second elastic member 14b, the core 42 present inside the second elastic member 14b is cooled. Consequently, even if any draft is not formed, the core 42 is easily collapsed due to thermal contraction. A method of cooling the core 42 is not particularly limited and is, for example a method of causing a refrigerant (for example, cooling water) to flow through a pipe installed inside the core 42 in advance.

Alternatively, the core 42 present inside the second elastic member 14b may be cooled before removing the molds 41A and 41B.

Furthermore, the second elastic member 14b is manufactured in the same manner as described above, for example, by installing a core inside a mold to form a precursor of the second elastic member 14b, removing the mold from the precursor of the second elastic member 14b and cutting the precursor of the second elastic member 14b. Consequently, even if any draft is not formed, the core is easily collapsed. Here, the precursor of the second elastic member 14b includes the same structure as the second elastic member 14b except that a length of the precursor in a direction in which the corrugated plate spring W extends is greater than a length of the second elastic member 14b in the direction.

The first elastic member 14a preferably has Poisson's ratio of 0.3 or less. When the Poisson's ratio of the first elastic member 14a is 0.3 or less, the first elastic member 14a easily absorbs changes in thickness due to expansion and contraction of the battery cell 11a. In addition, the Poisson's ratio of the first elastic member 14a is, for example, 0 or more.

A thickness of the first elastic member 14a when the battery cell 11a has a charging rate of 100% is not particularly limited, and is, for example, 0.05 mm or more and 0.1 mm or less.

The first elastic member 14a is, for example, a foam having a porosity of 30% or more and 95% or less. A material constituting the foam is not particularly limited, and examples thereof include polyurethane, silicone resin, ethylene propylene rubber, styrene resin, olefin resin, polyamide, and polyester.

The second elastic member 14b preferably has Young's modulus of 35 GPa or more. When the Young's modulus of the second elastic member 14b is 35 GPa or more, the second elastic member 14b easily absorbs changes in thickness due to the expansion and contraction of the battery cell 11a. In addition, the Young's modulus of the second elastic member 14b is, for example, 200 GPa or less.

A material constituting the second elastic member 14b is not particularly limited, and examples thereof include metals such as stainless steel and carbon steel, resins such as epoxy resin, phenol resin and nylon resin, and fiber-reinforced plastic (FRP) such as carbon fiber-reinforced plastic (CFRP) and glass fiber-reinforced plastic (GFRP). Among these examples, FRP is preferable, in consideration of energy density of the battery module 10.

A thickness of the second elastic member 14b when the battery cell 11a has a charging rate of 100% is not particularly limited and is, for example, 1.0 mm or more and 1.2 mm or less.

The battery cell 11a is not particularly limited, and examples thereof include a solid-state battery cell such as an all-solid-state lithium metal battery cell, and an electrolyte battery cell such as a lithium metal battery cell. Among these examples, the solid-state battery cell is preferable.

Hereinafter, a case in which the battery cell 11a is an all-solid-state lithium metal battery cell will be described.

In the all-solid-state lithium metal battery cell, for example, a positive electrode current collector, a positive electrode composite layer, a solid electrolyte layer, a lithium metal layer, and a negative electrode current collector are sequentially laminated.

The positive electrode current collector is not particularly limited and is, for example, an aluminum foil.

The positive electrode composite layer contains a positive electrode active material and may further include a solid electrolyte, a conductive aid, a binder, or the like.

The positive electrode active material is not particularly limited if lithium ions can be absorbed and released, and examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}CO_{0.15}Al_{0.05})O₂, Li(Ni_{1/6}CO_{4/6}Mn_{1/6})O₂, Li(Ni_{1/3}CO_{1/3}Mn_{1/3})O₂, LiCoO₄, LiMn₂O₄, LiNiO₂, LiFePO₄, lithium sulfide, and sulfur.

A material as a solid electrolyte constituting the solid electrolyte layer is not particularly limited if the material can conduct lithium ions, and examples thereof include an oxide-based electrolyte and a sulfide-based electrolyte.

The negative electrode current collector is not particularly limited and is, for example, a copper foil.

As above, although embodiments of the present invention have been described, the present invention is not limited to the above embodiments, and the above embodiments may be appropriately altered within the meaning of the present invention.

### EXPLANATION OF REFERENCE NUMERALS

10 battery module
11 battery cell stack
11a battery cell
12 end plate
13 bind bar
14 cushioning material
14a first elastic member
14b second elastic member
W corrugated plate spring
R concave portion
C convex portion

What is claimed is:

1. A battery module comprising:
a battery cell stack in which a plurality of battery cells are stacked;
a pair of plate members provided at opposite ends of the battery cell stack in a stacking direction; and
a cushioning material disposed between the plurality of battery cells and/or between the battery cell stack and each of the plate members,
the cushioning material including a pair of first elastic members arranged on opposite outer sides in the stacking direction of the battery cell stack; and a second elastic member disposed between the pair of first elastic members, wherein
the second elastic member is a molding having a shape in which 2N layers (N being a natural number) of corrugated plate springs each having concave portions and convex portions that are alternately and continuously arranged, and extending in a predetermined direction are stacked in the stacking direction of the battery cell stack, and in which the concave portions and the convex portions of the corrugated plate springs adjacent to each other are integrated.

2. The battery module according to claim 1, wherein
in the second elastic member, a region in which the concave portion and the convex portion are integrated has a thickness greater than a thickness of a region in which the concave portion and the convex portion are not integrated.

3. The battery module according to claim 1, wherein
in the second elastic member, a region in which the concave portion and the convex portion are not integrated has rounded ends that are opposite to each other in a direction in which the concave portions and the convex portions are alternately and continuously arranged.

4. The battery module according to claim 1, wherein
each of the battery cells is a solid-state battery cell.

5. A method for manufacturing the battery module according to claim 1, comprising:
installing a core inside a mold;
molding the second elastic member by using the mold in which the core is installed; and
cooling the core that is present inside the second elastic member.

6. A method for manufacturing the battery module according to claim 1, comprising:
installing a core inside a mold;
molding a precursor of the second elastic member by using the mold in which the core is installed;
removing the mold from the precursor of the second elastic member; and
cutting the precursor of the second elastic member from which the mold has been removed, to obtain the second elastic member.
